(19) United States
(12) Patent Application Publication
(10) Pub. No.: US 2010/0253279 A1
(43) Pub. Date: Oct. 7, 2010

(54) SYSTEM, INCLUDING AN ELECTRICAL DEVICE AND A RECHARGEABLE BATTERY, ELECTRICAL DEVICE, AND RECHARGEABLE BATTERY

(76) Inventor: Wolf Matthias, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/743,718

(22) PCT Filed: Oct. 10, 2008
(86) PCT No.: PCT/EP08/63627

§ 371 Date: May 19, 2010

(30) Foreign Application Priority Data
Nov. 19, 2007 (DE) 102007055184.5

(51) Int. Cl. H02J 7/00; H01M 10/02

(52) U.S. Cl. 320/106; 429/7

(57) ABSTRACT

The invention relates to a system having an electrical device, particularly a hand-held electrical tool, and at least one accumulator equipped with a coding comprising at least one electrical conductor, for supplying the electrical device with electrical energy, and having an identification mechanism interacting with the coding, which includes an electrical controller. The controller is configured to enable the operation of the electrical device along with the accumulator only if the coding identifies the accumulator as being approved for the electrical device. The invention proposes that the identification mechanism includes at least two electrical contacts that may be connected to each other in an electrically conductive manner by the electrical conductor of a coding identifying the accumulator as approved for the electrical device. The controller is configured to enable the operation of the electrical device along with the accumulator upon detecting an electrically conductive connection between the contacts. The invention further relates to an electrical device and an accumulator.

### PRIOR ART

The invention relates to a system, including an electrical device, in particular a handheld electrical tool or a battery charger, and to at least one rechargeable battery as generically defined by the preamble to claim 9. The invention further relates to an electrical device as generically defined by the preamble to claim 9 and to a rechargeable battery for cooperation with an electrical device as generically defined by the preamble to claim 10.

Electrical devices are increasingly being equipped with more and more powerful rechargeable batteries. If electrical devices are operated with counterfeit batteries, this can lead to destruction of the electrical device. Moreover, if batteries are defective or unsuitable for that electrical device, there is the risk of short circuiting, and hence of causing a fire. For users of electrical devices, it is becoming increasingly more difficult to distinguish counterfeit batteries from batteries that are permitted for the electrical device. Rechargeable batteries that have a code embodied as an electrical resistor have therefore become known. By determining the resistance, a control unit provided in the electrical device can ascertain whether the battery is permitted for the electrical device or not, and as a consequence can enable the operation of the electrical device with the battery, or not.

Besides overcoming the problems discussed above, it would be desirable to furnish a simple coding option for coding battery properties.

### DISCLOSURE OF THE INVENTION

### Technical Object

The object of the invention is to propose an alternative system, including an electrical device and a battery, that enables the operation of the electrical device solely with the rechargeable batteries permitted for that electrical device. The object is also to propose an alternative electrical device that can be operated only with a battery permitted for it. The object is furthermore to propose a battery with a code of simple construction code that provides information as to whether a battery is permitted for a certain electrical device or not.

### Technical Solution

This object is attained with regard to the system by the characteristics of claim 1, with regard to the electrical device by the characteristics of claim 9, and with regard to the battery with the characteristics of claim 10. Advantageous refinements of the invention are defined by the dependent claims. All possible combinations of at least two of the characteristics disclosed in the specification, the claims, and/or the drawings also come within the scope of the invention.

The invention is based on the concept of embodying the control unit of the identification means of the electrical device in such a way that it identifies a battery as being permitted for the electrical device, if the control unit ascertains that there is an electrically conductive connection between two electrical contacts of the identification means. In other words, it is not necessary, as in the prior art, for the control unit to determine a resistance of a resistor code in a complicated way; instead, it is sufficient to ascertain an electrically conductive connection between the at least two contacts. This can be done for instance by means of measuring current or voltage. Especially preferably, the at least two contacts are digital inputs of the control unit. A control unit embodied in accordance with the concept of the invention makes it possible to use rechargeable batteries that have a code that is embodied substantially more simply than in the prior art. Thus the code need not include a resistor element; instead, it suffices if the code includes at least one electrical conductor, which, if the battery is a battery permitted for the electrical device, is contactable at at least two points spaced apart from one another by the contacts, preferably embodied as wiper contacts or spring contacts, of the identification means of the electrical device. If the battery is recognized by the electronic control unit of the electrical device as being permitted for the electrical device, or in other words an electrically conductive connection exists between the at least two electrical contacts of the identification means, then the control unit makes use of the electrical device with the battery possible. Preferably, the control unit as a consequence rescinds a barrier or blockage, as a result of which the electrical device can be operated with the battery. For instance, the control unit actuates a power switch, which enables the flow of current from the battery to a drive motor of the electrical device.

Alternatively, an embodiment is feasible in which the code and the identification means are transposed compared to the version described just above. To avoid repetition, the embodiment described first above will be the only one explained. This disclosure can be adopted in transposed form to an embodiment in which the code and the identification means are transposed.

An embodiment of the system or of the battery in which the code not only includes at least one electrical conductor but in which the code solely comprises one or more electrical conductors is of particular advantage. In addition, as needed, further codes of different construction can be provided, to minimize the risk of misidentifications.

In a refinement of the invention, it is advantageously provided that the at least one electrical conductor is embodied as a platelike component, in particular as a metal plate. Such an embodiment of the at least one electrical conductor has the advantage that it can be contacted in a simple way by the contacts, preferably embodied as spring contacts, of the identification means of the electrical device. The requirements in terms of production tolerances for exact positioning of the electrical conductor and/or of the contacts are minimal if the electrical conductor is embodied as a metal plate.

An embodiment of the system or battery in which the metal plate is affixed to or integrated with the battery housing by means of partial spray-coating with plastic is especially advantageous. This plastic is preferably the plastic that forms the battery housing. Securing the metal plate is preferably done by placing the metal plate in an injection mold before the battery housing is injection-molded, as a result of which, once the battery housing is completed, the metal plate forms a surface portion of the battery housing.

If more than two electrical contacts are provided in the electrical device, then one or more battery properties can be encoded by means of different positioning and/or a different number of electrical conductors on the battery. By detecting the interconnection of the contacts, the control unit can read out corresponding battery properties. Thus by ascertaining an electrically conductive connection between a first and a second contact of the identification means, for instance, the control unit recognizes that the battery is one that is permitted for the electrical device. If for instance the control unit additionally detects an electrically conductive connection between the first or second contact and a third contact, this means that the battery is a 12-volt battery. If no electrically conductive contact is found between the third contact and a fourth contact, the battery is for instance a 24-volt battery. Alternatively, if there is an electrically conductive connection between the third contact and a fourth contact, the control unit concludes that the battery is a 12-volt battery.

In a refinement of the invention, the control unit is embodied such that as a function of detecting or not detecting a battery property, the control unit adjusts at least one operating parameter for operating the electrical device. For instance, the control unit can adjust the electrical device between, to remain with the previous example, a 12-volt mode of operation and a 24-volt mode of operation. Also, the maximum operating power furnished by a drive motor of the electrical device can be limited as a function of the quantity of energy made available by the battery.

An embodiment in which the code, that is, the at least one electrical conductor, is a component of a battery locking means is especially preferred. Preferably, the at least one electrical conductor is disposed at least in some portions on a locking element that is adjustable relative to a battery housing. This locking element is for instance a pivotable pawl of the battery. In this way, the identification of the battery can be combined with the detection as to whether the battery is correctly inserted. This increases safety in operation of the electrical device, since an identification of the battery and hence enabling of the battery is possible only in the locked state of the battery.

The invention also leads to an electrical device, in particular an handheld electrical tool or a battery charger, that is embodied for operation with a battery. The electrical device includes identification means which have a control unit that is embodied such that, based on the finding of an electrically conductive connection between two contacts of the identification means, it enables the operation of the electrical device with the battery, for instance by the lifting of a barrier. As for possible embodiment options of the electrical device, to avoid repetition, reference is made to the electrical device disclosed in conjunction with the system described above.

The invention also leads to a battery, provided with a code, for an electrical device. According to the invention, it is provided that the at least one electrical conductor, associated with the identification means of the electrical device, is embodied and disposed such that it can be contacted, at at least two spaced-apart points, by at least two electrical contacts of the identification means. Preferably, the at least one contact is a metal plate disposed on a surface of the battery housing. By means of suitable shaping and/or disposition of at least one and preferably more electrical conductors, battery properties can be encoded in a simple way and made readable in a simple way for a control unit of the identification means.

### BRIEF DESCRIPTION OF THE DRAWINGS

Further advantages, characteristics and details of the invention will become apparent from the ensuing description of preferred exemplary embodiments as well as from the drawings. In the drawings:

FIG. 1 is a perspective view of a battery for an electrical device; and

FIG. 2 shows a battery, disposed on an electrical device that is only partially shown.

### EMBODIMENTS OF THE INVENTION

In the drawings, identical components and components with the same function are identified by the same reference numerals.

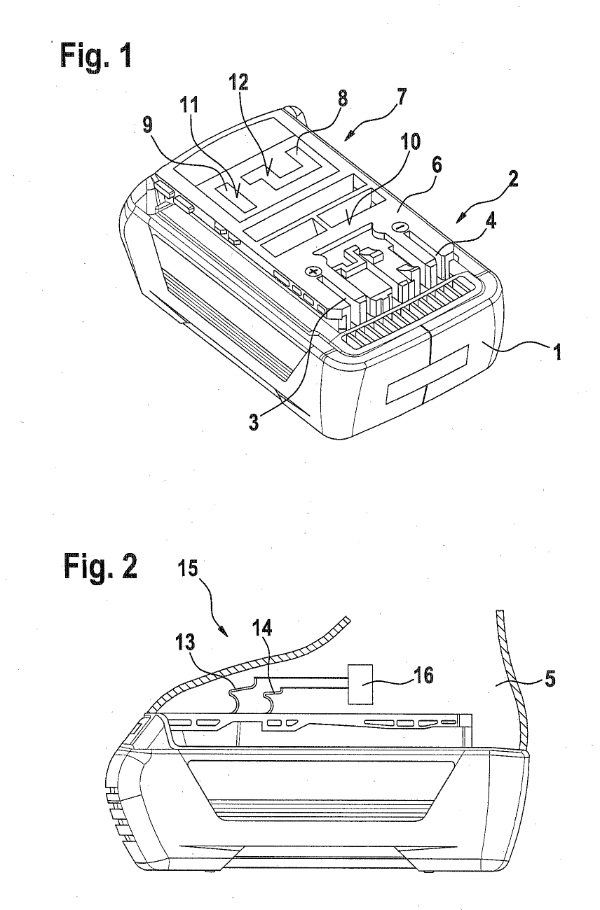

In FIG. 1, a battery 2, embodied as a removable electrical tool base 1, is shown for an electrical device, not shown but embodied as a handheld electrical tool. The battery 2 includes two electric supply terminals 3, 4 (positive pole, negative pole) for connection to corresponding supply contacts (not shown) of an electrical device 5 shown only partially in FIG. 2.

The battery 2 has a battery housing 6, which is equipped with a code 7 that identifies the battery 2. In the exemplary embodiment shown, the code 7 includes solely two spaced-apart, differently shaped electrical conductors 8, 9, each embodied as a metal plate. The electrical conductors 8, 9 are disposed on a top side 10, oriented toward the electrical device 5 in operation, of the battery 2.

The electrical conductors 8, 9 embodied as metal plates are spray-coated laterally and on their undersides with the plastic of the battery housing 6. The surfaces 11, 12 of the electrical conductors 8, 9 that are oriented toward the electrical device 5 are contactable by contacts 13, 14, embodied as spring contacts, of identification means 15 of the electrical device 5 (see FIG. 2).

It can be seen from FIG. 2 that the contacts 13, 14 are embodied as spring elements, which are prestressed by the battery 2 affixed to the electrical device 5, so that the contacts 13, 14, with their face ends, can cooperate with the electrical conductors 8, 9. Only two contacts 13, 14 are shown in FIG. 2, as an example. The contacts 13, 14 are electrically conductively connected to a control unit 16 with which it can be ascertained whether an electrically conductive connection exists between the contacts 13, 14 or not.

If the electrical conductor 9, for instance, shown in FIG. 1 is provided on the battery 2, then the contacts 13, 14 are connected electrically conductively to one another. From this, the control unit 16 concludes that the battery 2 is one permitted for the electrical device 5, and as a consequence it enables operation of the electrical device 5, for instance by enabling an electrical connection line from the supply terminals 3, 4 to a drive motor. If because of the absence of an electrical conductor 9 or of some otherwise-shaped and/or disposed electrical conductor upon insertion of the battery 2, no electrically conductive connection is made between the contacts 13, 14, then the battery 2 is identified by the control unit 16 as not being permitted for the electrical device 5, and as a consequence a blockage, and thus the electrical device 5 cannot be operated with that battery 2.

Besides the information as to whether the battery is a permitted battery 2, the code 7 encodes at least one battery property. For instance, if in addition to the contacts 13, 14 shown, more than two further contacts are provided, all or some of which are connected to one another by the electrical conductor 8, then the control unit 16, from the resultant interconnection of these contacts by means of the electrical conductors 8, 9 can identify battery properties and can adjust appropriate operating parameters in the electrical device.

1-13. (canceled)

14. A system having an electrical device, in particular having a handheld electrical tool or a battery charger, and having at least one rechargeable battery provided with a code that includes at least one electrical conductor, and having identification means cooperating with the code, that have an electronic control unit, and the control unit is embodied as enabling operation of the electrical device with the battery only for the case in which the code identifies the battery as permitted for the electrical device, the identification means including at least two electrical contacts which are connectable electrically conductively to one another by the electrical conductor of a code identifying the battery as being permitted for the electrical device, wherein the control unit is embodied such that, when it detects an electrically conductive connection between the contacts, it enables the operation of the electrical device with the battery.

15. The system as defined by claim 14, wherein the code comprises solely at least one electrical conductor.

16. The system as defined by claim 14, wherein the electrical conductor is embodied as a metal plate.

17. The system as defined by claim 15, wherein the electrical conductor is embodied as a metal plate.

18. The system as defined by claim 16, wherein the metal plate is disposed on a side face of the battery oriented toward the battery charger.

19. The system as defined by claim 17, wherein the metal plate is disposed on a side face of the battery oriented toward the battery charger.

20. The system as defined by claim 14, wherein the metal plate is partly spray-coated with plastic, in particular with a plastic that forms a battery housing of the battery.

21. The system as defined by claim 15, wherein the metal plate is partly spray-coated with plastic, in particular with a plastic that forms a battery housing of the battery.

22. The system as defined by claim 17, wherein the metal plate is partly spray-coated with plastic, in particular with a plastic that forms a battery housing of the battery.

23. The system as defined by claim 14, wherein more than electrical contacts are provided; and that the control unit, as a function of the detection of the interconnection of at least two of the contacts, is embodied as identifying at least one battery property.

24. The system as defined by claim 22, wherein more than electrical contacts are provided; and that the control unit, as a function of the detection of the interconnection of at least two of the contacts, is embodied as identifying at least one battery property.

25. The system as defined by claim 14, wherein the control unit is embodied as adjusting parameters for operating the electrical device, as a function of the battery property identified.

26. The system as defined by claim 24, wherein the control unit is embodied as adjusting parameters for operating the electrical device, as a function of the battery property identified.

27. The system as defined by claim 14, wherein the code is disposed at least partially and preferably completely on a locking element that is adjustable, preferably pivotable, relative to a battery housing, preferably being disposed such that the contacting of the contacts with the electrical conductor of the code is possible only in a state of the locking element that locks the battery.'

28. The system as defined by claim 26, wherein the code is disposed at least partially and preferably completely on a locking element that is adjustable, preferably pivotable, relative to a battery housing, preferably being disposed such that the contacting of the contacts with the electrical conductor of the code is possible only in a state of the locking element that locks the battery.

29. An electrical device, in particular a handheld electrical tool or battery charger, which is embodied for operation with a battery, and the electrical device has identification means that include an electronic control unit, and the control unit is embodied such that it enables operation of the electrical device with the battery only for a case in which the code identifies the battery as permitted for the electrical device, the identification means including at least two electrical contacts, which are connectable electrically conductively to one another by the electrical conductor of a code identifying the battery as being permitted for the electrical device, wherein the control unit is embodied such that, when it detects an electrically conductive connection between the contacts, it enables the operation of the electrical device with the battery.

30. A rechargeable battery, in particular for an electrical device as defined by claim 29, having a code that has at least one electrical conductor, wherein the electrical conductor is embodied and disposed such that, at at least two points spaced apart from one another, it is contactable by at least two electrical contacts of identification means of the electrical device.

31. A system having an electrical device, in particular an electrical tool or battery charger, that is provided with a code including at least one electrical conductor, and having a battery, which has identification means that cooperate with the code and that have an electronic control unit including an identification means, and the control unit is embodied as enabling operation of the electrical device with the battery only for the case in which the code identifies the battery as permitted for the electrical device, the identification means including at least two electrical contacts, which are connectable electrically conductively to one another by the electrical conductor of a code identifying the battery as being permitted for the electrical device, wherein the control unit is embodied such that, when it detects an electrically conductive connection between the contacts, it enables the operation of the electrical device with the battery.

32. A rechargeable battery for an electrical device, the battery having identification means that include an electronic control unit, and the control unit is embodied such that it enables operation of the electrical device with the battery only for the case in which the code identifies the battery as permitted for the electrical device, the identification means including at least two electrical contacts, which are connectable electrically conductively to one another by the electrical conductor of a code identifying the battery as being permitted for the electrical device, wherein the control unit is embodied such that, when it detects an electrically conductive connection between the contacts, it enables the operation of the electrical device with the battery.

33. An electrical device, in particular a handheld electrical tool or battery charger, which is embodied for operation with a battery, in particular one embodied in accordance with claim 32, having a code that has at least one electrical conductor, wherein the electrical conductor is embodied and disposed such that, at at least two points spaced apart from one another, it is contactable by at least two electrical contacts of identification means of the battery.
